(19) United States
(12) Patent Application Publication
(10) Pub. No.: US 2011/0247012 A1
(43) Pub. Date: Oct. 6, 2011

(54) COMMUNICATION PROCESSING APPARATUS, COMMUNICATION PROCESSING METHOD, AND STORAGE MEDIUM

(75) Inventor: Yasuhiko Uehara, Tokyo (JP)

(73) Assignee: CANON KABUSHIKI KAISHA, Tokyo (JP)

(21) Appl. No.: 13/027,017

(22) Filed: Feb. 14, 2011

(30) Foreign Application Priority Data
Mar. 31, 2010 (JP) 2010-083403
Dec. 20, 2010 (JP) 2010-283734

(51) Int. Cl. G06F 9/44

(52) U.S. Cl. 719/318

(57) ABSTRACT

According to one aspect of the invention, a communication processing apparatus comprises a first communication unit and a second communication unit, wherein the second communication unit comprises: a storage unit configured to store correspondence information indicating correspondence between a process ID of a process operating on the information processing apparatus and a logical ID preassigned to the process; an acquisition unit configured to acquire a process ID corresponding to a logical ID of a destination process by referring to the storage unit; an execution unit configured to execute communication with a process operating on the information processing apparatus, which process has the process ID acquired by the acquisition unit; and an invalidation unit configured to invalidate the correspondence information of each process operating on the information processing apparatus, when notified by the notification unit that the information processing apparatus has stopped.

### BACKGROUND OF THE INVENTION

1. Field of the Invention

The present invention relates to a communication processing apparatus connected to a node of a network via middleware, and a method of controlling the apparatus.

2. Description of the Related Art

In recent software system development, a method of dividing software into components is being promoted. More specifically, software is divided into components (parts) less dependent on each other, and these components are arranged on a plurality of information processing apparatuses (nodes) having various communication channels. These components operate while communicating with each other. In addition, communication middleware to centrally control communication is introduced to the inter-component communication. This communication middleware hides different communication channels and integrates communication interfaces. This integration of the interfaces improves the maintenability of the system, and increases the productivity by the reuse of the components.

In this integrated interface, information that is to be used as an ID to specify a component as a communication partner is an important matter in system design. This is because the information to be used affects the flexibility of component design and the operation speed of the system.

Generally, as the ID for specifying a communication partner, it is possible to use a physical ID which is less abstract, or a logical ID which is more abstract. The former is a method (to be referred to as “a communication method using a physical ID” hereinafter) that performs communication by using a physical ID comprising information about physical location such as a node on which a communication partner is located, a process to which the communication partner belongs, and an associated queue (hereinafter simply referred to as “physical location”). The latter is a method that specifies a communication partner by using a logical ID which is more abstract such as the component name. In the latter method, communication middleware manages the relation between the component name and the physical information of the communication partner, and converts the logical ID into the physical information (for example, the physical ID) when performing communication. (This method will be referred to as “a communication method using a logical ID” hereinafter).

“The communication method using a physical ID” can reduce the communication processing time and perform high-speed communication, because the ID contains information specifying a communication path. On the other hand, this method decreases the flexibility to component design.

Furthermore, in “the communication method using a logical ID”, the conversion process to convert the logical ID into physical information must be performed whenever performing communication. In a system including a plurality of nodes, the physical information of components on each of the nodes is centrally managed. In “the communication method using a logical ID”, therefore, it takes a significant time to access the physical information of a communication destination component from a communication source component, that is, the process of converting the logical ID into the physical information is time-consuming. This increases the calculation cost for communication. However, each component can be arranged on any of a plurality of nodes when performing an operation, and this increases the flexibility of design.

A method using both the physical ID and logical ID in order to fully utilize the merits of both is possible. That is, the logical ID is converted into the physical information only for the first time during communication, and communication is performed using the obtained physical information from the second time (this method will be referred to as “a method using a logical ID only for the first time” hereinafter). This method can achieve both a high degree of design flexibility and fast communication speed. However, in a system where the physical location of a component changes while the system is in operation, the physical information of a communication destination must be corrected by some methods.

Japanese Patent Laid-Open No. 2009-009607 relates to middleware that manages the correspondence between the physical location information and logical name of data using a table, thereby hiding the physical location. When the physical location is changed, the table is automatically updated, so the program at an access source need not be aware of the change in data location.

Japanese Patent Laid-Open No. 2007-281839 has proposed a method which, if a bus reset occurs, scans a network configuration to check whether there is a change, and updates a correspondence table between physical location information and logical position information if there is a change.

In a system including a plurality of nodes, only a given node is sometimes restarted while the system itself is in operation. If a given node is restarted, information such as a process ID to which a component on this node belongs sometimes changes.

For example, if a given node is restarted after it is stopped, a component arranged on the node is terminated once and then restarted. In a general computer OS, process IDs are assigned in order of activation. Also, in a system including a plurality of processes, the activation order of the processes is not strictly uniquely determined.

That is, if a given node is restarted, a component arranged on the node is not necessarily assigned the same process ID as that before the restart. Consequently, the physical location which is indicated by the physical ID containing the process ID may be different from that before the restart. In this case, “the method using a logical ID only for the first time” cannot perform normal communication any longer because the physical information of a communication destination changes. To acquire correct physical information of the communication partner, the conversion process of converting the logical ID into the physical information must be reexecuted after the given node is restarted. If a large number of components exist in a system, however, installing the node restart detecting process and reconverting process in all the components increases the cost and is inefficient.

In the method of Japanese Patent Laid-Open No. 2009-009607, a system including a plurality of nodes must centrally manage information of components on each of the nodes. If a table for managing this information is accessed whenever performing an operation, the communication load may increase.

Also, in Japanese Patent Laid-Open No. 2007-281839, whenever information changes due to bus reset, the location information is updated by scanning all devices (communication endpoints). This increases the traffic because, for example, information of a component operating on a device not to be restarted is unnecessarily updated.

### SUMMARY OF THE INVENTION

The present invention has been made in consideration of the above situation, and provides a technique capable of performing normal communication in a communication processing apparatus including a plurality of communication components connected to a network via middleware, even when the physical location of a communication destination component on the network changes.

According to one aspect of the invention, a communication processing apparatus comprises a first communication unit which communicates with an information processing apparatus, and a second communication unit which communicates with a process operating on the information processing apparatus via the first communication unit, wherein the first communication unit comprises a notification unit configured to notify the second communication unit of stop of the information processing apparatus, and the second communication unit comprises: a storage unit configured to store correspondence information indicating correspondence between a process ID of a process operating on the information processing apparatus and a logical ID preassigned to the process; an acquisition unit configured to acquire a process ID corresponding to a logical ID of a destination process by referring to the storage unit; an execution unit configured to execute communication with a process operating on the information processing apparatus, which process has the process ID acquired by the acquisition unit; and an invalidation unit configured to invalidate the correspondence information of each process operating on the information processing apparatus, when notified by the notification unit that the information processing apparatus has stopped.

According to another aspect of the invention, a communication processing method is provided for a communication processing apparatus comprising a first communication unit which communicates with an information processing apparatus, and a second communication unit which communicates with a process operating on the information processing apparatus via the first communication unit, wherein the second communication unit comprises a storage unit configured to store correspondence information indicating correspondence between a process ID of a process operating on the information processing apparatus and a logical ID preassigned to the process; wherein the method comprising the steps of: the second communication unit acquiring a process ID corresponding to a logical ID of a destination process by referring to the storage unit; the second communication unit executing communication with a process operating on the information processing apparatus, which process has the process ID acquired by the acquisition unit; and the first communication unit notifying the second communication unit of stop of the information processing apparatus, and the second communication unit invalidating the correspondence information of each process operating on the information processing apparatus, when notified by the notification unit that the information processing apparatus has stopped.

According to still another aspect of the invention, a computer-readable storage medium is provided, which computer-readable storage medium stores a computer program which causes a computer to function as a communication processing apparatus comprising a first communication unit which communicates with an information processing apparatus, and a second communication unit which communicates with a process operating on the information processing apparatus via the first communication unit, wherein the first communication unit comprises a notification unit configured to notify the second communication unit of stop of the information processing apparatus, and the second communication unit comprises: a storage unit configured to store correspondence information indicating correspondence between a process ID of a process operating on the information processing apparatus and a logical ID preassigned to the process; an acquisition unit configured to acquire a process ID corresponding to a logical ID of a destination process by referring to the storage unit; an execution unit configured to execute communication with a process operating on the information processing apparatus, which process has the process ID acquired by the acquisition unit; and an invalidation unit configured to invalidate the correspondence information of each process operating on the information processing apparatus, when notified by the notification unit that the information processing apparatus has stopped.

Further features of the present invention will become apparent from the following description of exemplary embodiments (with reference to the attached drawings).

### BRIEF DESCRIPTION OF THE DRAWINGS

FIG. 1 is a view showing a whole communication processing system;

FIG. 2 is a view showing an example of a physical ID;

FIG. 3 is a view showing a practical example of an ID conversion table;

FIG. 4 is a view showing a configuration used in “a communication method using a physical ID”;

FIG. 5 is a view showing a message transmission flowchart performed in “the method using a physical ID”;

FIG. 6 is a view showing a configuration used in “a communication method using a logical ID”;

FIG. 7 is a view showing a message transmission flowchart performed in “the method using a logical ID”;

FIG. 8 is a message transmission flowchart performed in “a communication method using a logical ID only for the first time”;

FIG. 9 is a view showing a message transmission flowchart of the present invention;

FIG. 10 is a view showing a processing flowchart performed when detecting node stop in the present invention;

FIG. 11 is a view showing an additional processing flowchart of the present invention;

FIG. 12 is a system view showing details of the hardware configuration of a communication processing apparatus (node); and

FIG. 13 is a view showing a communication flowchart performed between a component and communication middleware.

### DESCRIPTION OF THE EMBODIMENTS

### First Embodiment

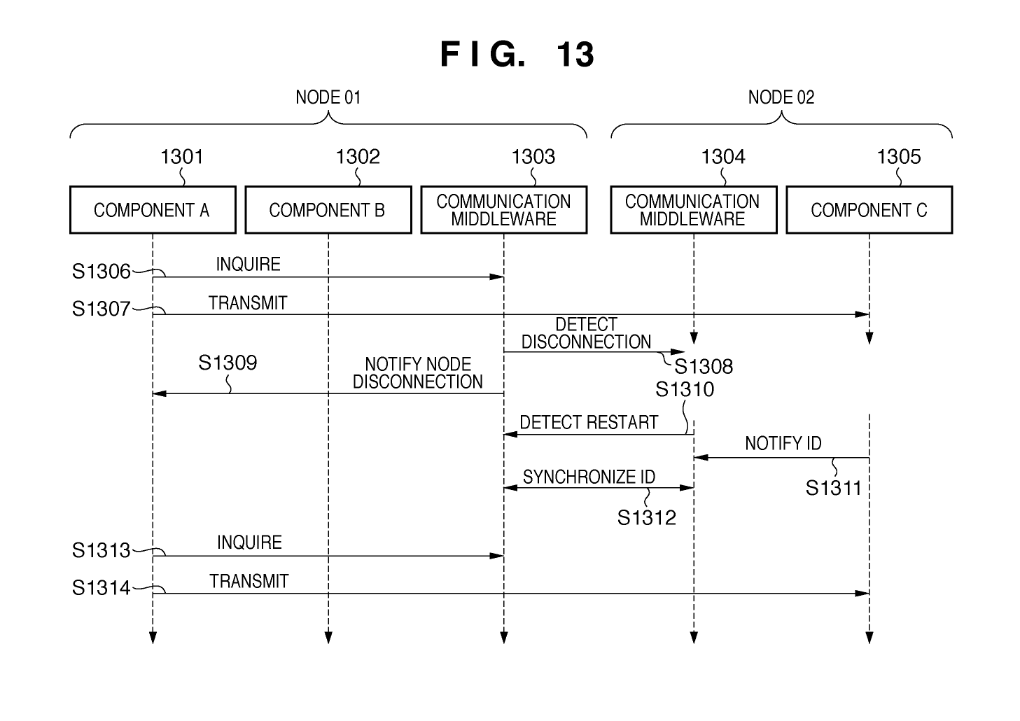

FIG. 12 is a view showing a configuration example of a communication processing apparatus according to the first embodiment. Referring to FIG. 12, each of nodes 01 and 02 is the communication processing apparatus according to this embodiment. In FIG. 12, the nodes 01 and 02 can communicate with each other via a communication path 12. The arrangement of the node 01 will be explained in detail below. The node 02 has the same arrangement as that of the node 01. Therefore, a detailed explanation of the node 02 will be omitted.

The node 01 includes a CPU 13, network controller 03, and memory 05 connected to each other by a system bus 04. The memory 05 is divided for each process by a memory protecting mechanism of the CPU 13. In the example shown in FIG. 12, communication middleware (a first communication unit) and components A and B are operating on the node 01. Accordingly, a communication middleware memory space 06, component A memory space 07, and component B memory space 08 exist in the memory 05.

The memory spaces 06 to 08 each independently hold a conversion table between a logical ID and physical ID. That is, conversion tables 09, 10, and 11 respectively exist in the communication middleware memory space 06, component A memory space 07, and component B memory space 08. As described above, the node 01 is connected to the node 02 via the communication path 12. The communication middleware of the node 01 communicates with the node 02 via the network controller 03.

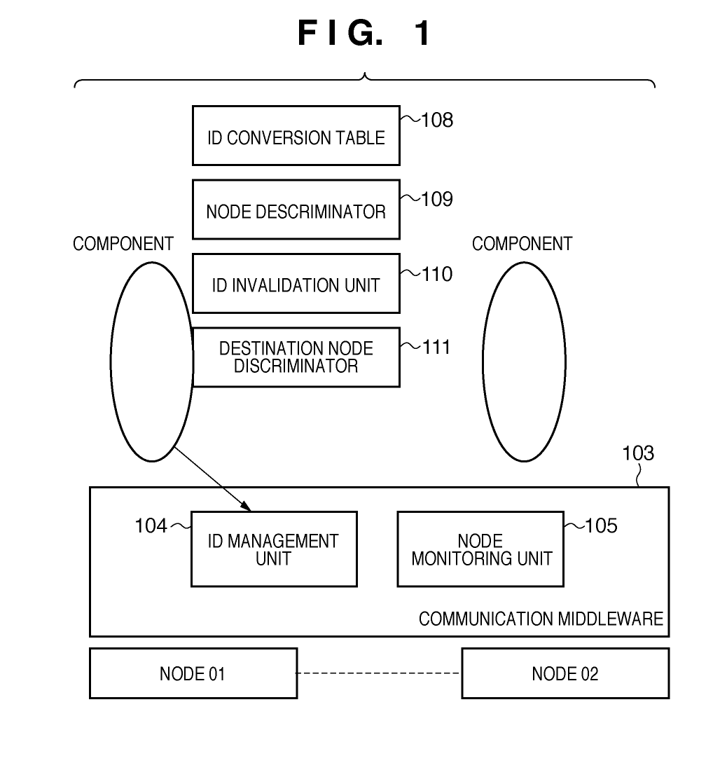

FIG. 1 is a view showing an outline of a communication processing system in which communication components communicate with each other across a network. This communication processing system includes nodes 01 and 02 as communication processing apparatuses (information processing apparatuses). This communication processing system also includes communication middleware 103 for providing a communication function, and a plurality of components A and B. The communication middleware 103 has a function of abstracting communication between nodes and between components. As explained above with reference to FIG. 12, the communication middleware is operating on each of the nodes 01 and 02. These communication middlewares implement the communication middleware 103 shown in FIG. 1 by cooperating with each other. More specifically, the communication middleware 103 includes an ID management unit 104 and node monitoring unit 105. The node monitoring unit 105 monitors the state of each node constructing the system, and manages whether the node is presently operating or stopping. The plurality of software components A and B each of which is a communication endpoint are operating on the communication middleware 103 (see FIG. 4). Component A is operating on the node 01, and component B is operating on the node 02. An ID conversion table 108 (storage unit), node discriminator 109, and ID invalidation unit 110 are arranged in component A as a communication component (second communication unit). The communication middleware 103 has a function of interpreting a physical ID indicating the physical location of a communication component, and a logical ID independent of the component location.

The communication middleware 103 may also include a destination node discriminator 111. The destination node discriminator 111 cooperates with the node discriminator 109, and discriminates a node to which a destination component belongs from a physical ID as the destination of a message.

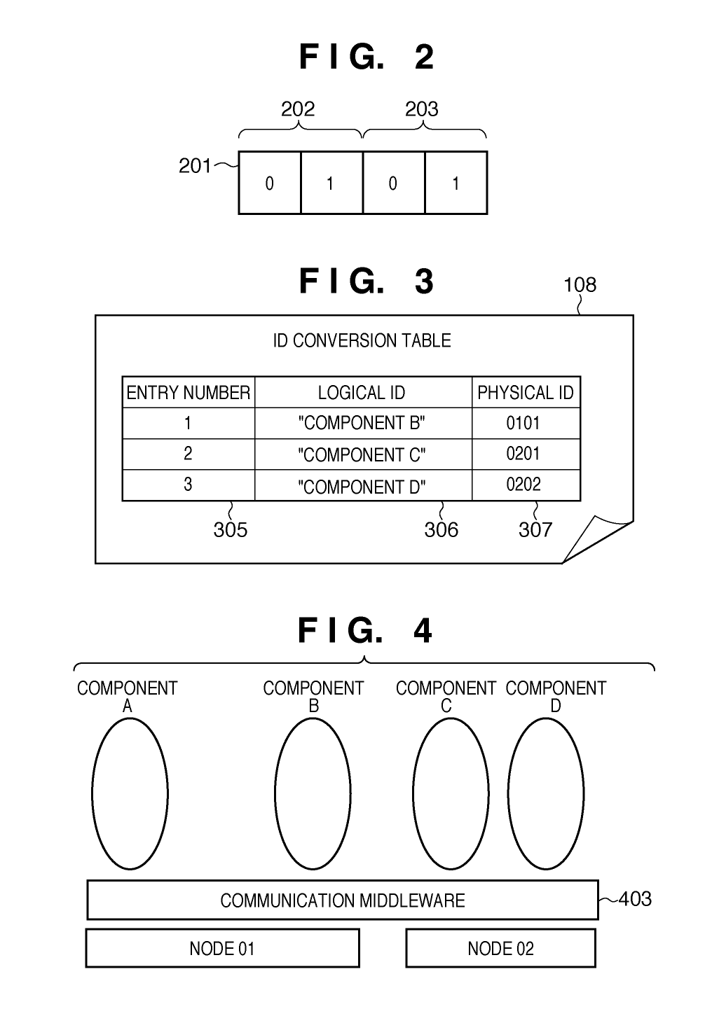

FIG. 2 shows an example of the physical ID indicating the physical location of a communication component on the network in the first embodiment. A physical ID 201 has a numerical value of four digits. The physical ID 201 is a combination of a two-digit node ID 202 for identifying a node in which the component is located, and a two-digit process ID 203 for identifying a process in which the component is located.

FIG. 3 shows a practical example of the ID conversion table 108 installed in each component for communication. The ID conversion table 108 is held in each component. Accordingly, high-speed processing is possible compared to, for example, “the communication method using a logical ID” in which the conversion function provided by the communication middleware is used whenever performing communication. As shown in FIG. 3, identification information for a communication partner (communication destination) component includes an entry number 305, logical ID 306, and physical ID 307, and the physical ID 307 contains information of a node and process.

FIG. 3 shows the ID conversion table 108 held by component A. Pieces of information of three components, that is, components B, C, and D as communication partners are registered in the ID conversion table 108. The ID conversion table 108 associates the entry number 305, the logical ID, and the physical ID 201 indicating the physical location with each other, for each registered component. More specifically, the entry number 305 is a serial number capable of identifying the destination in the ID conversion table 108, the logical ID 306 expresses the destination component by a character string, and the physical ID 307 expresses the physical information of the destination component. In the example shown in FIG. 3, the physical IDs of components B, C, and D are respectively 0101, 0201, and 0202. These physical IDs mean that components B, C, and D are respectively located on process 01 of node 01, process 01 of node 02, and process 02 of node 02. As described above, this ID conversion table stores correspondence information indicating the correspondence between the process ID of a component (process) and the logical ID preassigned to the component (process).

First, the system configurations and the operations of message transmission using the communication middleware in “the communication method using a physical ID”, “the communication method using a logical ID”, and “the communication method using a logical ID only for the first time” of the prior art will be explained. The following explanation will clarify differences from the first embodiment of the present invention.

FIGS. 4 and 5 are views for explaining a general “communication method using a physical ID”. As shown in FIG. 4, communication middleware 403 is installed in a system including two nodes 01 and 02. A plurality of software components A, B, C, and D are operating on the communication middleware 403. Component A is located on node 01, and a process ID to which component A belongs is 01. Similarly, components B, C, and D respectively belong to process 02 on node 01, process 01 on node 02, and process 02 on node 02. Physical IDs representing components A, B, C, and D are respectively 0x0101, 0x0102, 0x0201, and 0x0202.

The operation of “the communication method using a physical ID” will be explained below with reference to a flowchart shown in FIG. 5. In S501, a given component receives a transmission instruction, and starts a message transmission process. In S502, the communication middleware specifies the physical ID of a destination component from the physical ID of the destination. In “the communication method using a physical ID”, a communication component designates the destination by the physical ID. The physical ID contains the physical information of the destination component as shown in FIG. 2, so the load of this specification process is small.

In S503, the communication middleware performs an actual message transmission process by using the specified destination physical ID. In S504, a transmission result is obtained in accordance with whether the destination exists. If communication to the destination is successful, that is, if the destination exists, the communication is successful, and the process advances to S505. If an error such as the nonexistence of the destination occurs in S504, the communication is unsuccessful, and the process advances to S506.

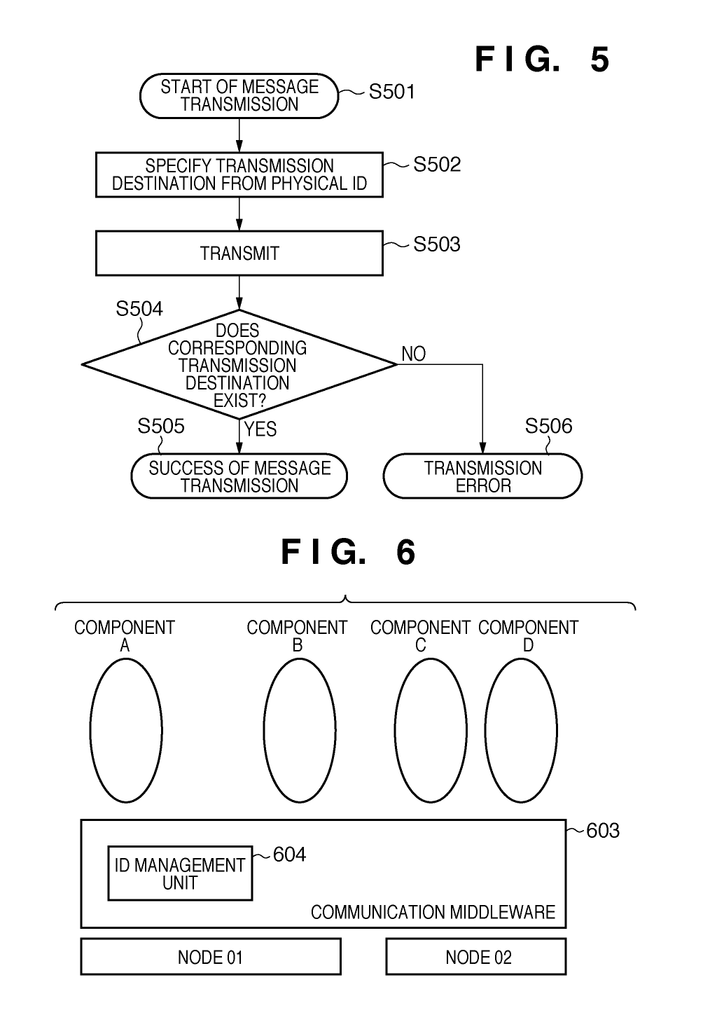

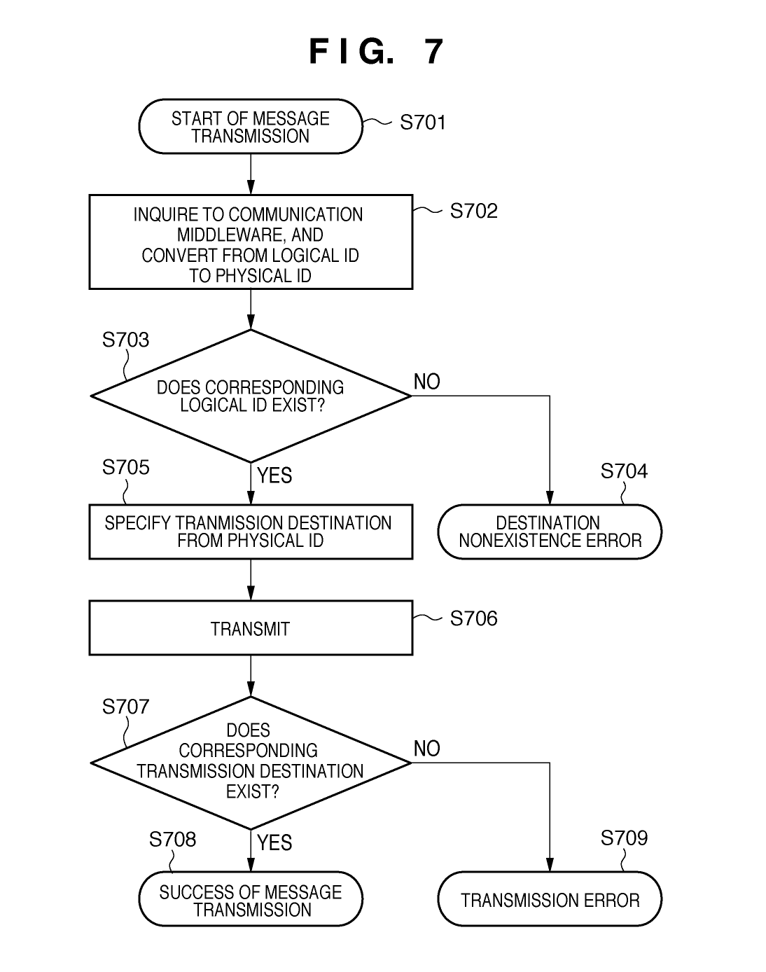

FIGS. 6 and 7 are views for explaining “the communication method using a logical ID”. Referring to FIG. 6, communication middleware 603 is installed in a system including two nodes 01 and 02. The communication middleware 603 includes an ID management unit 604. A plurality of software components A, B, C, and D are operating on the communication middleware 603. Component A is located on node 01, and a process ID to which component A belongs is 01. Likewise, components B, C, and D respectively belong to process 02 on node 01, process 01 on node 02, and process 02 on node 02. Physical IDs representing components A, B, C, and D are respectively 0x0101, 0x0102, 0x0201, and 0x0202.

The operation of “the communication method using a logical ID” will be explained below with reference to a flowchart shown in FIG. 7. In S701, a communication component receives a transmission instruction, and starts a message transmission process. At this point of time, the communication component has received the logical ID of the destination. In S702, the communication component makes an inquiry to the communication middleware 603. The ID management unit 604 of the communication middleware 603 converts the logical ID into a physical ID. In “the communication method using a logical ID”, a communication component designates the destination by the logical ID. As this logical ID, the communication component designates, for example, a character string representing the component name. Also, the ID management unit 604 of the communication middleware must dynamically and unitarily manage information of components on each of a plurality of nodes.

In S703, the ID management unit 604 in the communication middleware having received the inquiry determines whether a component having the designated logical ID exists in the system. If the corresponding component does not exist in the system, an error indicating the nonexistence of the destination is transmitted to the transmission source component in S704.

If the corresponding component exists in the system, the process of converting the logical ID into a physical ID is performed. The procedure after that is the same as that of “the communication method using a physical ID” explained with reference to FIG. 5. That is, in S705, the ID management unit 604 specifies the destination component from the physical ID.

In S705, the ID management unit 604 performs an actual transmission process with respect to the specified destination component. In S707, the ID management unit 604 determines whether the communication is successful. If the destination is finally found, the communication is successful, and the process advances to S708; if not, the process advances to S709 by regarding that there is an error.

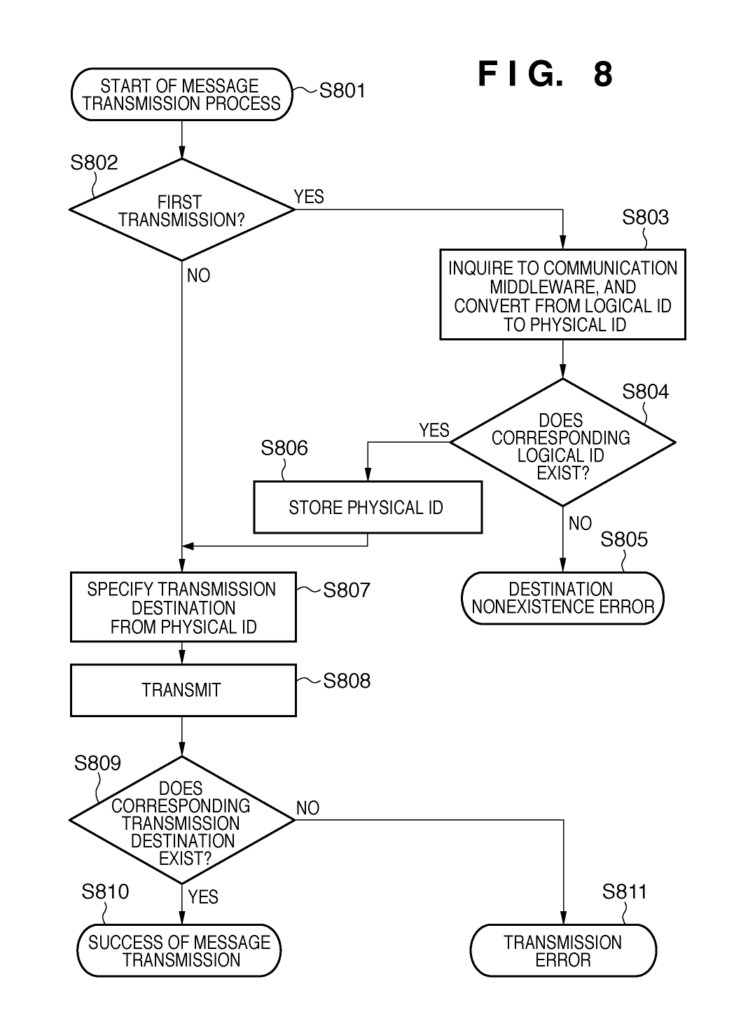

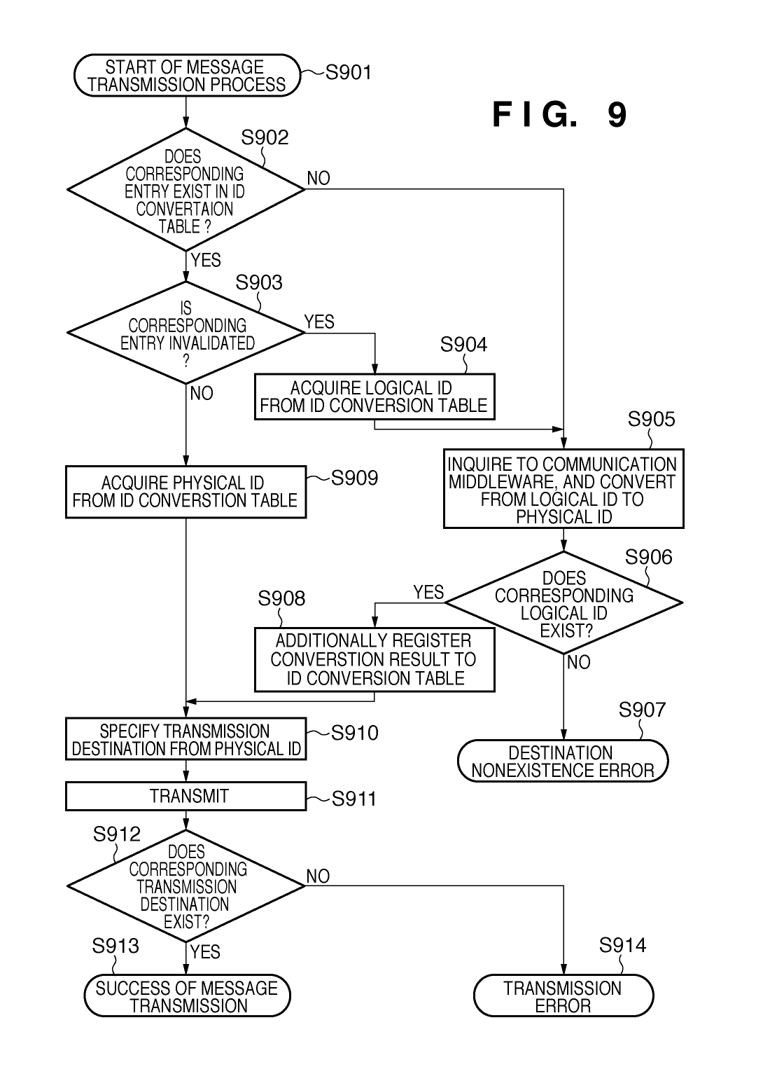

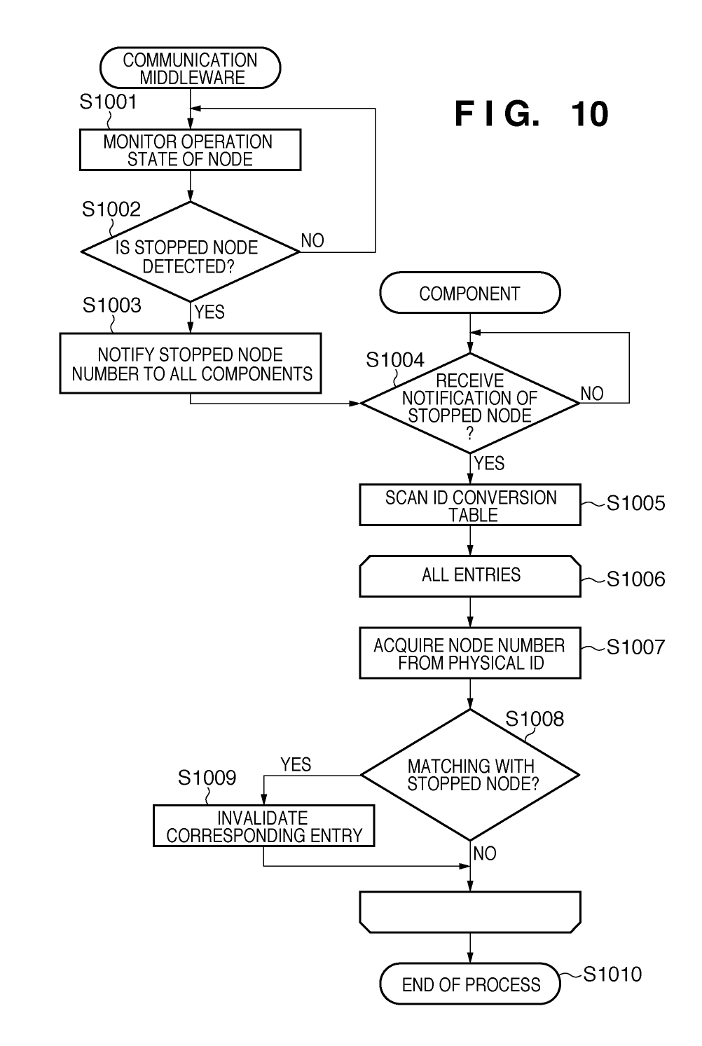

FIG. 8 is a view for explaining the prior art “communication method using a logical ID only for the first time”. The system configuration of this prior art is the same as that of “the communication method using a logical ID” shown in FIG. 6. In S801, a communication component starts a message transmission process. In S802, the communication component determines whether this is the first transmission to the corresponding destination.

If the communication component determines that this is the first transmission, the process advances to S803. In S803, the communication component makes an inquiry to the communication middleware 603, and the ID management unit 604 converts the logical ID into a physical ID. The destination is designated by the logical ID in the first communication, in “the communication method using a logical ID only for the first time”.

In S804, the ID management unit 604 in the communication middleware 603 determines whether a component having the designated logical ID exists in the system, as in “the communication method using a logical ID”. This step is the same as the procedure in S703. If the corresponding component does not exist in the system, the ID management unit 604 returns an error indicating the nonexistence of the destination, in S805. This step is the same as S704.

If the corresponding component exists in the system and the ID management unit 604 successfully converts the logical ID into a physical ID, the process advances to S806, and the ID management unit 604 stores the converted physical ID in an internal memory of the component (not shown, a memory space of the process to which the component belongs). Since the physical ID is stored, it is unnecessary to execute S803 which requires a high cost, from the second transmission.

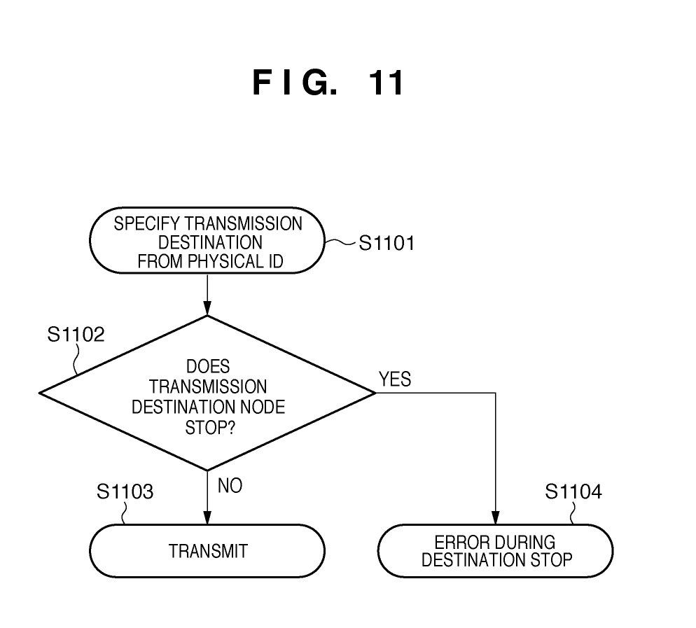

After the physical ID is stored, or if the communication component determines in S802 that this is the second or subsequent communication, the ID management unit 604 performs communication by using the physical ID. The procedure after that is the same as that of “the communication method using a logical ID” shown in FIG. 7. That is, steps from S807 to S811 respectively correspond to the steps from S705 to S709 in FIG. 7, so a repetitive explanation will be omitted. An embodiment of the present invention will be explained below. FIG. 9 is a flowchart showing the operation of a component that transmits a message in this embodiment. FIG. 10 is a flowchart showing the operation of communication middleware when node stop is detected in this embodiment. The system configuration of this embodiment is the same as that explained with reference to FIG. 1.

In S901, a communication component starts a message transmission process. In S902, the communication component refers to the ID conversion table 108 in the component, and determines whether an entry corresponding to the transmission destination exists in the table. In this embodiment, as indicated by the configuration of the ID conversion table 108 shown in FIG. 3, the destination can be designated by either the logical ID or the entry number in the ID conversion table.

If the entry is found in the ID conversion table 108, the process advances to S903, and the component determines whether the entry is invalidated. (The process of invalidating the entry in the ID conversion table 108 will be described later with reference to FIG. 10.)

If the entry is already invalidated, the process advances to S904, and the component acquires the logical ID contained in the entry from the ID conversion table 108. In addition, in S905, the communication component makes an inquiry to the communication middleware 103. The ID management unit 104 performs the process of converting the logical ID into a physical ID. This process is the same as S702 in “the communication method using a logical ID”, and an inquiry to the communication middleware 103 occurs.

If no entry corresponding to the transmission destination exists in S902, the communication component similarly makes an inquiry to the communication middleware 103 by using the logical ID designated as the destination (an inquiry unit). In S905, the ID management unit 104 converts the logical ID into a physical ID. The ID management unit 104 has a central ID table in which the physical IDs of all components on the network are centrally registered. The ID management unit 104 converts the logical ID designated as the destination into a corresponding physical ID by referring to this central ID table. That is, correspondence information indicating the correspondence between the process ID and logical ID of each component (process) is stored in the central ID table.

Then, in S906, the communication middleware 103 determines whether a component having the designated logical ID exists in the system by using the ID management unit 104 in the communication middleware 103, as in S703 of “the communication method using a logical ID”. If the corresponding component is unregistered and does not exist, the process advances to S907, and the communication middleware returns an error indicating the nonexistence of the destination to the communication component. This process is the same as S704.

If the ID management unit 104 successfully converts the logical ID into a physical ID in S906, the process advances to S908, and the communication component additionally registers a combination of the physical ID and the logical ID obtained as a result of conversion in the ID conversion table 108 (a registration unit). More specifically, if no transmission destination entry exists in S902, the component generates a new entry and additionally registers it in the ID conversion table 108. Alternatively, if it is determined in S903 that the entry is invalidated, the communication component updates the entry by using the physical ID reacquired in S905 as a correct physical ID.

If it is determined in S903 that the entry as the transmission destination is not invalidated but valid, the communication component acquires a physical ID from the entry in S909. This process is, for example, the process of extracting an ID from an ID conversion table 108 that corresponds to the ID conversion table 108 shown in FIG. 3 and is held in the transmission source component. Accordingly, the process of making an inquiry to the communication middleware as in S905 does not occur.

If the physical ID is acquired in S909, or if the additional registration to the ID conversion table 108 is complete in S908, the communication component performs communication by using the obtained physical ID. The procedure after that is the same as that of “the communication method using a logical ID” shown in FIG. 7. That is, steps S910 to S914 correspond to steps S705 to S709 shown in FIG. 7, so a repetitive explanation will be omitted. As described above, the conversion table 108 is reconstructed in steps S902 to S906 and S908 shown in FIG. 9.

The process of invalidating the entry in the ID conversion table 108, which may occur due to the partial restart of a node, will be explained below with reference to FIG. 10. In S1001, the communication middleware 103 monitors the operation states of all nodes constructing the system. In S1002, the communication middleware 103 detects whether there is a stopped node. If a stopped node is detected, the communication middleware 103 notifies all components of information of the stopped node, in S1003. In this step, the node monitoring unit 105 in the communication middleware 103 actually detects the stop of the node and performs the notification. All components having received the notification performs the following process.

Each component notified of the stop in S1004 first scans the ID conversion table 108 held in the component in S1005. More specifically, the component performs the following processing for all entries contained in the table (S1006). In S1007, the component acquires the node number from the physical ID held in the entry. The node discriminator 109 identifies a node corresponding to the physical ID. This identification is performed by the node discriminator 109, and corresponds to the process of extracting the two upper digits of the physical ID as described previously with reference to FIG. 2.

Subsequently, in S1008, the component having received the notification compares the node extracted in S1007 with the stopped node notified in S1002, and determines whether the two nodes match. If the two nodes match, the process advances to S1009. In S1009, the component determines that the entry relates to the stopped node, and the ID invalidation unit 110 invalidates the entry. More specifically, it is possible to add a flag to the entry, or update the physical ID with an invalid value. The invalidated entry is used to determine whether the ID is invalid when transmitting a message in S903. The above processing is performed for all entries, and terminated in S1010.

The operations of the component and communication middleware before and after node restart will be explained below with reference to FIG. 13. Referring to FIG. 13, node 01 includes components 1301 and 1302 and communication middleware 1303. Node 02 includes communication middleware 1304 and a component 1305.

First, communication performed by the component 1301 before node 02 is restarted will be explained below. Assume that the component 1301 intends to communicate with the component 1305 whose logical ID is known. Assume also that the physical ID of the component 1305 is not registered in the ID conversion table of the component 1301.

In S1306, the component 1301 inquires of the communication middleware 1303 located on the same node as that of the component 1301 about the physical ID of the component 1305. More specifically, the component 1301 transmits the logical ID of the component 1305 as a communication target to the communication middleware 1303, and requests the transmission of the physical ID of the component 1305. After acquiring the physical ID of the component 1305, the component 1301 transmits data to the component 1305 in S1307 (an execution unit). Also, as described previously, the component 1301 registers information containing the logical ID and physical ID of the component 1305 in the ID conversion table.

Assume that node 02 has stopped. In S1308, the communication middleware 1303 of node 01 detects the stop of node 02. The stop of node 02 can be detected by various methods. For example, a network controller of node 01 can detect the interruption of a communication path. Alternatively, if periodical communication between the communication middleware 1303 and communication middleware 1304 is interrupted, the communication middleware can determine that the communication path is disconnected.

In S1309, the middleware 1303 notifies the components 1301 and 1302 located on node 01 of the stop of node 02. As described previously with reference to FIG. 10, the components 1301 and 1302 having received this notification each check its own ID conversion table, and invalidate the entry of the component 1305 located on node 02.

Assume that node 02 is restarted. In S1310, the communication middleware 1304 of restarted node 02 notifies other nodes of the restart of node 02. More specifically, the communication middleware 1304 notifies the communication middleware 1303 of the restart of node 02.

Assume that the component 1305 located on node 02 is also restarted after that. In this case, a controller (for example, an operating system (not shown)) of node 02 assigns a process ID to the component 1305. In this embodiment, a physical ID includes a node ID and process ID, and the node ID is normally fixed. When the process ID is assigned, therefore, the component 1305 knows its physical ID. However, the controller of node 02 can also directly notify the component 1305 of the physical ID.

In S1311, the component 1305 notifies the physical ID of the component 1305 to the communication middleware 1304 of node 02 on which the component 1305 is located. The communication middleware 1304 stores the physical ID and logical ID of the component 1305 in the ID conversion table of the communication middleware 1304, such that the two IDs are associated with each other.

In S1312, the communication middleware 1303 of node 01 and the communication middleware 1304 of node 02 synchronize their ID conversion tables. In the example shown in FIG. 13, in S1312, the physical ID and logical ID of the component 1305 are stored as they are associated with each other in the ID conversion table held by the communication middleware 1303 of node 01. This synchronization of the ID conversion tables may also be performed every predetermined time, or in response to the addition of information concerning a newly activated component to communication middleware on a given node.

Assume that the component 1301 intends to communicate with the component 1305 in this state. As described above, the information of the component 1305 is deleted from the ID conversion table of the component 1301 in S1309. In S1313, therefore, the component 1305 makes an inquiry to the communication middleware 1303, as in S1306.

Finally, in S1314, the component 1301 transmits data to the component 1305, as in S1307. Thus, the component 1301 inquires of the communication middleware 1303 the physical ID of the component 1305 in S1313. Accordingly, the data is correctly transmitted to the component 1305 although the physical ID of the component 1305 may have changed because node 02 is restarted.

In this embodiment, in the period from the timing at which the physical location of the destination component is specified in S910 to the timing at which transmission is actually performed in S911, the communication component can determine the operation state of the node to which the destination component belongs. If the node has been stopped, the transmission may be inhibited. This determination makes it possible to prevent a transmission error or transmission timeout that occurs if the transmission process is performed for a stopped node.

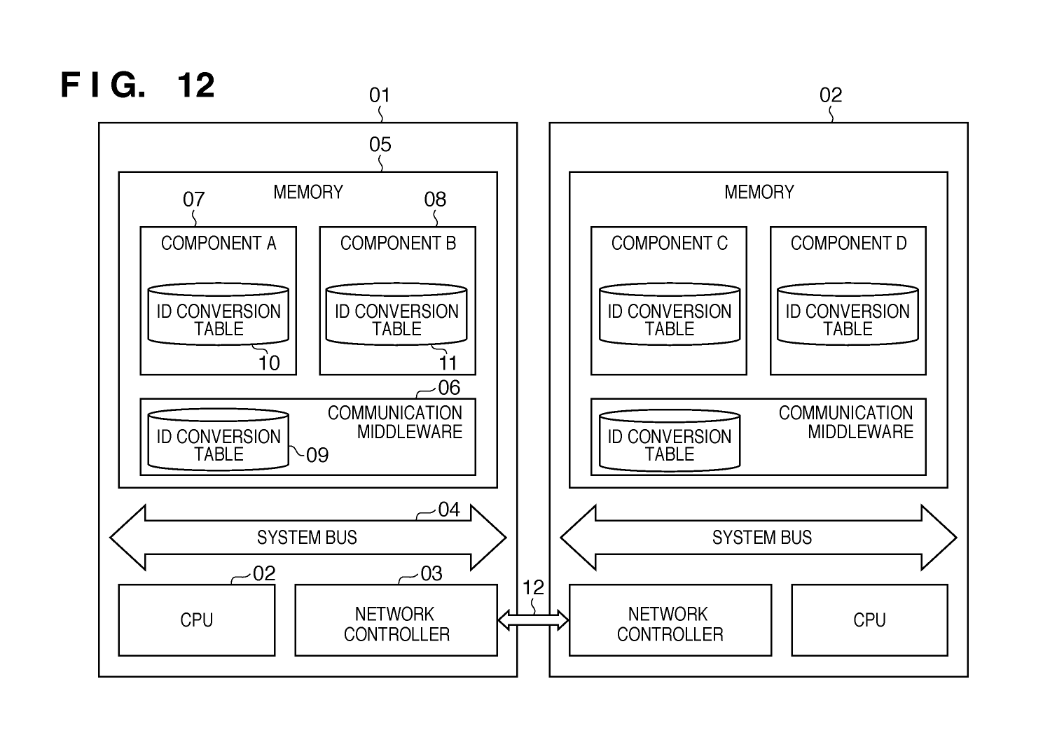

This additional processing will be explained below with reference to FIG. 11. In S1101, the physical information of the destination is specified from the physical ID of the destination component (this is equivalent to the processing in S910). In S1102, whether a node to which the destination component belongs has been stopped is determined. Since the physical information of the destination component is specified in S1101, the node as a determination target can uniquely be determined.

If it is determined that the corresponding node is in operation, actual transmission is performed in S1103 (this is equivalent to the processing in S911). If the corresponding node is not in operation, actual transmission is inhibited by generating an error in S1104. If is, of course, also possible to invalidate the entry shown in FIG. 10 if the node is not in operation.

The control as described above makes it possible to achieve flexible component design using the logical ID and high-speed communication using the physical ID. It is also possible to cope with the change in physical ID when a given node constructing the system is stopped and restarted. Furthermore, the configuration of this embodiment can inhibit the complication of component installation.

### Other Embodiments

The above embodiment has been explained by assuming that each component is located in a process of a node. That is, communication with a component of a node means communication with a process of the node. Also, in the above-described embodiment, the logical ID is a character string expressing the destination component. However, the logical ID is not limited to a character string, and can also be a numerical value or the like. Each component may be preassigned a unique logical ID. For example, different logical IDs can be assigned to components operating on a node with which node 01 can communicate.

In the above-described embodiment, the middleware has the ID conversion table, and synchronizes it with the ID conversion table of the middleware of another node. However, the middleware need not have any ID conversion table. For example, a management node (not shown) can store the logical ID and physical ID of each component such that the two IDs are associated with each other. In this case, when a component inquires of the middleware the physical ID corresponding to the logical ID, the middleware can acquire the physical ID by making an inquiry to the management node.

In the example shown in FIG. 12, the communication middleware and component are implemented by executing a program by a node such as a personal computer. However, it is apparent to those skilled in the art that the communication processing apparatus according to the present invention can also be constructed by dedicated hardware. That is, the communication processing apparatus according to the present invention can also be constructed by a circuit operating as communication middleware, and a circuit operating as a component in the communication processing apparatus.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-083403, filed Mar. 31, 2010, and No. 2010-283734, filed Dec. 20, 2010, which are hereby incorporated by reference herein in their entirety.

What is claimed is:

1. A communication processing apparatus comprising a first communication unit which communicates with an information processing apparatus, and a second communication unit which communicates with a process operating on said information processing apparatus via said first communication unit, wherein
said first communication unit comprises a notification unit configured to notify said second communication unit of stop of said information processing apparatus, and
said second communication unit comprises:
a storage unit configured to store correspondence information indicating correspondence between a process ID of a process operating on said information processing apparatus and a logical ID preassigned to the process;
an acquisition unit configured to acquire a process ID corresponding to a logical ID of a destination process by referring to said storage unit;
an execution unit configured to execute communication with a process operating on said information processing apparatus, which process has the process ID acquired by said acquisition unit; and
an invalidation unit configured to invalidate the correspondence information of each process operating on said information processing apparatus, when notified by said notification unit that said information processing apparatus has stopped.

2. The apparatus according to claim 1, wherein said second communication unit further comprises:
an inquiry unit configured to, if the correspondence information of a destination process is not stored in said storage unit or invalidated, inquire of said first communication unit a process ID corresponding to the logical ID of the destination process; and
a registration unit configured to acquire the process ID of the destination process from said first communication unit as a response to the inquiry, and stores, in said storage unit, the correspondence information indicating correspondence between the process ID and the logical ID of the destination process.

3. The apparatus according to claim 2, wherein said first communication unit further comprises:
a management unit configured to store correspondence information indicating correspondence between a process ID of a process operating on each of a plurality of information processing apparatuses, and the logical ID of the process; and
a transmission unit configured to, when receiving the inquiry from said second communication unit, acquire a process ID corresponding to the logical ID of the destination process by referring to said management unit, and transmit the acquired process ID to said second communication unit.

4. A communication processing method for a communication processing apparatus comprising a first communication unit which communicates with an information processing apparatus, and a second communication unit which communicates with a process operating on said information processing apparatus via said first communication unit,
wherein said second communication unit comprises a storage unit configured to store correspondence information indicating correspondence between a process ID of a process operating on said information processing apparatus and a logical ID preassigned to the process;
wherein said method comprising the steps of:
said second communication unit acquiring a process ID corresponding to a logical ID of a destination process by referring to said storage unit;
said second communication unit executing communication with a process operating on said information processing apparatus, which process has the process ID acquired by said acquisition unit; and
said first communication unit notifying said second communication unit of stop of said information processing apparatus, and
said second communication unit invalidating the correspondence information of each process operating on said information processing apparatus, when notified by said notification unit that said information processing apparatus has stopped.

5. A computer-readable storage medium storing a computer program which causes a computer to function as a communication processing apparatus comprising a first communication unit which communicates with an information processing apparatus, and a second communication unit which communicates with a process operating on said information processing apparatus via said first communication unit, wherein
said first communication unit comprises a notification unit configured to notify said second communication unit of stop of said information processing apparatus, and
said second communication unit comprises:
a storage unit configured to store correspondence information indicating correspondence between a process ID of a process operating on said information processing apparatus and a logical ID preassigned to the process;
an acquisition unit configured to acquire a process ID corresponding to a logical ID of a destination process by referring to said storage unit;
an execution unit configured to execute communication with a process operating on said information processing apparatus, which process has the process ID acquired by said acquisition unit; and
an invalidation unit configured to invalidate the correspondence information of each process operating on said information processing apparatus, when notified by said notification unit that said information processing apparatus has stopped.
